(19) United States
(12) Patent Application Publication
(10) Pub. No.: US 2017/0212575 A1
(43) Pub. Date: Jul. 27, 2017

(54) POWER BUDGET ALLOCATION METHOD AND APPARATUS FOR GENERATING POWER MANAGEMENT OUTPUT ACCORDING TO SYSTEM SETTING OF MULTI-CORE PROCESSOR SYSTEM AND TARGET POWER BUDGET

(71) Applicant: MEDIATEK INC., Hsin-Chu (TW)

(72) Inventors: Wei-Ting Wang, Taipei City (TW); Han-Lin Li, Taoyuan City (TW); Yingshiuan Pan, Kaohsiung City (TW); Yueh-Feng Lee, Taipei City (TW); Shun-Yao Yang, Taoyuan City (TW); Jih-Ming Hsu, Taoyuan City (TW)

(21) Appl. No.: 15/403,153

(22) Filed: Jan. 10, 2017

Related U.S. Application Data
(60) Provisional application No. 62/281,221, filed on Jan. 21, 2016.

(51) Int. Cl. G06F 1/32

(52) U.S. Cl. CPC G06F 1/324; G06F 1/3296

(57) ABSTRACT

A power budget allocation method includes: obtaining a system setting associated with a multi-core processor system, obtaining a target power budget, and checking, by a power management controller, at least one power management table according to the system setting and the target power budget to generate a power management output for the multi-core processor system. The system setting includes a core combination setting of the multi-core processor system, and further includes a frequency setting of each processor core selected by the core combination setting.

### CROSS REFERENCE TO RELATED APPLICATIONS

This application claims the benefit of U.S. provisional application No. 62/281,221, filed on Jan. 21, 2016 and incorporated herein by reference.

### BACKGROUND

The disclosed embodiments of the present invention relate to power management, and more particularly, to a power budget allocation method for generating a power management output according to a system setting of a multi-core processor system and a target power budget and an associated power budget allocation apparatus.

The system-on-chip (SoC) of a mobile device requires higher performance than ever, and therefore supports higher computing power. When the SoC is operated under a high computing power mode, heat dissipation becomes an important issue because the mobile device form-factor is small. To achieve higher computing power, a multi-core processor system may be employed by the SoC of the mobile device. The multi-core processor system, however, is a heat source needed to be monitored. If the temperature of the multi-core processor system exceeds a threshold temperature, the multi-core processor system may have a shorter lifespan due to permanent damage caused by the undesired temperature overshoot. To avoid the undesired temperature overshoot, the power budget of the multi-core processor system may be adaptively adjusted in response to the monitored temperature of the multi-core processor system. If the configuration of the multi-core processor system is properly adjusted to meet the target power budget requirement, the multi-core processor system may be protected from suffering from the undesired temperature overshoot. Thus, there is a need for an innovative power budget allocation design which is capable of efficiently adjusting the configuration of the multi-core processor system to meet the target power budget requirement.

### SUMMARY

In accordance with exemplary embodiments of the present invention, a power budget allocation method for generating a power management output according to a system setting of a multi-core processor system and a target power budget and an associated power budget allocation apparatus are proposed to solve the above-mentioned problem.

According to a first aspect of the present invention, an exemplary power budget allocation method is disclosed. The exemplary power budget allocation method includes: obtaining a system setting associated with a multi-core processor system, wherein the system setting comprises a core combination setting of the multi-core processor system and further comprises a frequency setting of each processor core selected by the core combination setting; obtaining a target power budget; and checking, by a power management controller, at least one power management table according to the system setting and the target power budget to generate a power management output for the multi-core processor system.

According to a second aspect of the present invention, an exemplary power budget allocation apparatus is disclosed. The exemplary power budget allocation apparatus includes a storage device and a power management controller. The storage device is configured to store at least one power management table. The power management controller is configured to obtain a system setting associated with a multi-core processor system, wherein the system setting comprises a core combination setting of the multi-core processor system and further comprises a frequency setting of each processor core selected by the core combination setting; obtain a target power budget; and check the at least one power management table according to the system setting and the target power budget to generate a power management output for the multi-core processor system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a power budget allocation apparatus according to an embodiment of the present invention.

FIG. 2 is a diagram illustrating an operation of creating a delta power table and a delta efficiency table according to an embodiment of the present invention.

FIG. 3 is a flowchart illustrating a power budget allocation method according to an embodiment of the present invention.

FIG. 4 is a flowchart illustrating sub-steps included in the step 316 shown in FIG. 3.

FIG. 5 is a diagram illustrating an example of decreasing an operation limit (e.g., a core limit L_{CORE}) of a cluster according to the step 316 shown in FIG. 4.

FIG. 6 is a flowchart illustrating sub-steps included in the step 314 shown in FIG. 3.

FIG. 7 is a diagram illustrating an example of increasing an operation limit (e.g., a frequency limit L_{FREQ}) of a cluster according to the step 314 shown in FIG. 6.

FIG. 8 is a block diagram illustrating another power budget allocation apparatus according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

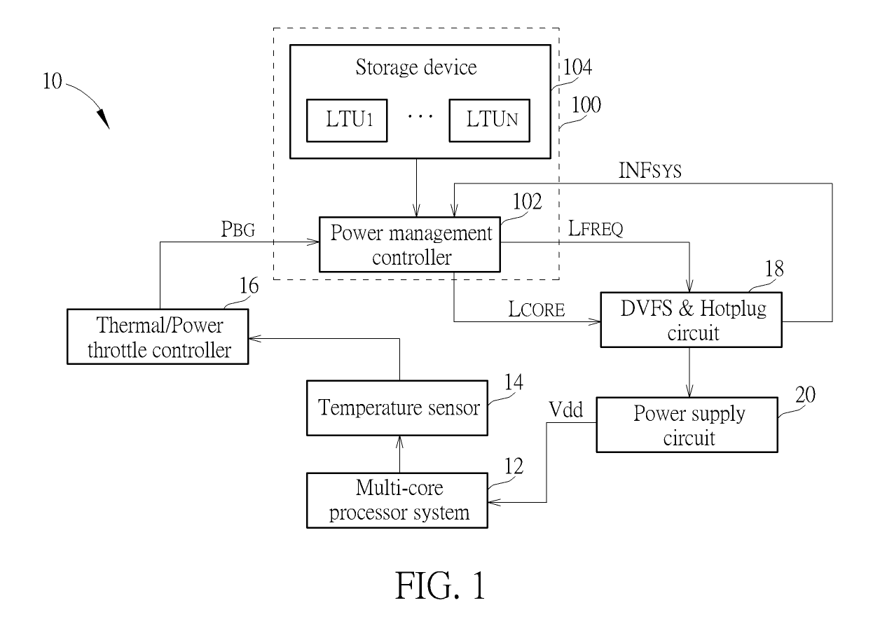

FIG. 1 is a block diagram illustrating a power budget allocation apparatus according to an embodiment of the present invention. The power budget allocation apparatus 100 may be a part of an electronic device 10. For example, the electronic device 10 maybe a mobile device such as a cellular phone. In addition to the power budget allocation apparatus 100, the electronic device 10 may also include other circuits associated with power management and thermal protection. For example, the electronic device 10 may further include, but not limited to, a multi-core processor system 12, a temperature sensor 14, a thermal/power throttle controller 16, a DVFS (Dynamic Voltage Frequency Scaling) & hotplug circuit 18, and a power supply circuit 20. The multi-core processor system 12 includes a plurality of processor cores. In this embodiment, a DVFS circuit and a hotplug circuit maybe collectively regarded as one processing circuit, i.e., DVFS & hotplug circuit 18. Each of the processor cores can be selectively enabled or disabled by the hotplug function of the DVFS & hotplug circuit 18. The frequency of each of the processor cores can be adaptively adjusted by the DVFS function of the DVFS & hotplug circuit 18. In addition, the power supply circuit 20 may include a buck converter (not shown) for generating a buck voltage (i.e., supply voltage) Vdd to each of online processor cores (i.e., processor cores enabled by the hotplug function). Hence, the buck voltage (i.e., supply voltage) Vdd of each of online processor cores can be adaptively adjusted by the power supply circuit 20 according to the frequency of the corresponding processor core that is adaptively adjusted by the DVFS function. The temperature sensor 14 detects temperature of the multi-core processor system 12 periodically, and therefore updates a detected temperature value periodically. The thermal/power throttle controller 16 reads the temperature value from the temperature sensor 14, and refers to the temperature value to determine a target power budget P_{BG} for the multi-core processor system 12.

In this embodiment, the power budget allocation apparatus 100 includes a power management controller 102 and a storage device 104. For example, the storage device 104 maybe a memory device. The storage device 104 is configured to store at least one power management table LUT₁-LUT_{N}, where the number N of power management tables LUT₁-LUT_{N} depends on the actual design considerations. In one exemplary design, multiple power management tables may be stored in the storage device 104, where N is a positive integer not smaller than one. In another exemplary design, a single power management table may be stored in the storage device 104, where N is a positive integer equal to one.

The power management controller 102 is a circuit configured to obtain a system setting INF_{SYS} associated with the multi-core processor system 12, obtain the target power budget P_{BG}, and check the at least one power management table LUT-LUT_{N} according to the system setting INF_{SYS} and the target power budget P_{BG} to generate a power management output for the multi-core processor system 12. In this embodiment, the system setting INF_{SYS} s is a runtime system setting set by the DVFS & hotplug circuit 18 and actually employed by the multi-core processor system 12. For example, the system setting INF_{SYS} includes a core combination setting which is an online core setting of the multi-core processor system 12, and further includes a frequency setting of each processor core selected by the core combination setting (i.e., online core setting) of the multi-core processor system 12. The system setting INF_{SYS} of the multi-core processor system 12 is selectively adjusted/updated by the DVFS & hotplug circuit 18 in response to the power management output generated from the power management controller 102.

The multi-core processor system 12 comprises a plurality of processor cores categorized into a plurality of clusters. In this embodiment, the power management output includes at least one of an online core limit L_{CORE} and a frequency limit L_{FREQ}for each of the clusters. In a case where the power management output includes a frequency limit L_{FREQ} for each of the clusters, the DVFS function of the DVFS & hotplug circuit 18 may decide a frequency setting of each online processor core categorized into the same cluster under the frequency constraint set by the corresponding frequency limit L_{FREQ} of the cluster. In another case where the power management output includes an online core limit L_{CORE} and a frequency limit L_{FREQ} for each of the clusters, the DVFS function of the DVFS & hotplug circuit 18 may decide a frequency setting of each online processor core categorized into the same cluster under the frequency constraint set by the corresponding frequency limit L_{FREQ} of the cluster, and the hotplug function of the DVFS & hotplug circuit 18 may decide an online core setting of a cluster under the core constraint set by the corresponding online core limit L_{CORE} of the cluster, where the online core setting of the overall multi-core processor system 12 is set by online core settings of clusters of the multi-core processor system 12. Since the present invention focuses on the power budget allocation scheme implemented using the power budget allocation apparatus 100, further description of the DVFS & hotplug circuit 18 is omitted here for brevity.

In a first exemplary design, the storage device 104 is configured to store two power management tables (N=2), including a delta power table LUT₁ and a delta efficiency table LUT₂. The multi-core processor system 12 has a plurality of processor cores categorized into a plurality of clusters, where each of the clusters supports a plurality of different core combinations of processor cores categorized into the same cluster, and each of the different core combinations may include one or more processor cores. For example, the multi-core processor system 12 may include “Big (B)” processor cores, “Middle (M) ” processor cores, and “Little (L) ” processor cores. If the “Big (B)” processor cores, “Middle (M)” processor cores and “Little (L)” processor cores do not have heterogeneous processor cores (e.g., “Middle (M)” processor cores and “Little (L)” processor cores) sharing the same buck voltage, the “Big (B)” processor cores are categorized into a first cluster that is supplied with a first buck voltage, the “Middle (M) ” processor cores are categorized into a second cluster that is supplied with a second buck voltage, and the “Little (L)” processor cores are categorized into a third cluster that is supplied with a third buck voltage. If the “Middle (M)” processor cores and “Little (L) ” processor cores share the same buck voltage, the “Big (B)” processor cores are categorized into a first cluster that is supplied with a first buck voltage, and the “Middle (M)” processor cores and the “Little (L) ” processor cores are categorized into a second cluster (which is a buck-voltage-shared cluster) that is supplied with a second buck voltage.

Regarding each of the core combinations supported by the same cluster, the delta power table LUT₁ records a plurality of delta power values associated with different operating performance point (OPP) transitions, respectively, and the delta efficiency table LUT₂ records a plurality of delta power efficiency values associated with the different OPP transitions, respectively. Further details of creating the delta power table LUT₁ and the delta efficiency table LUT₂ are described as below.

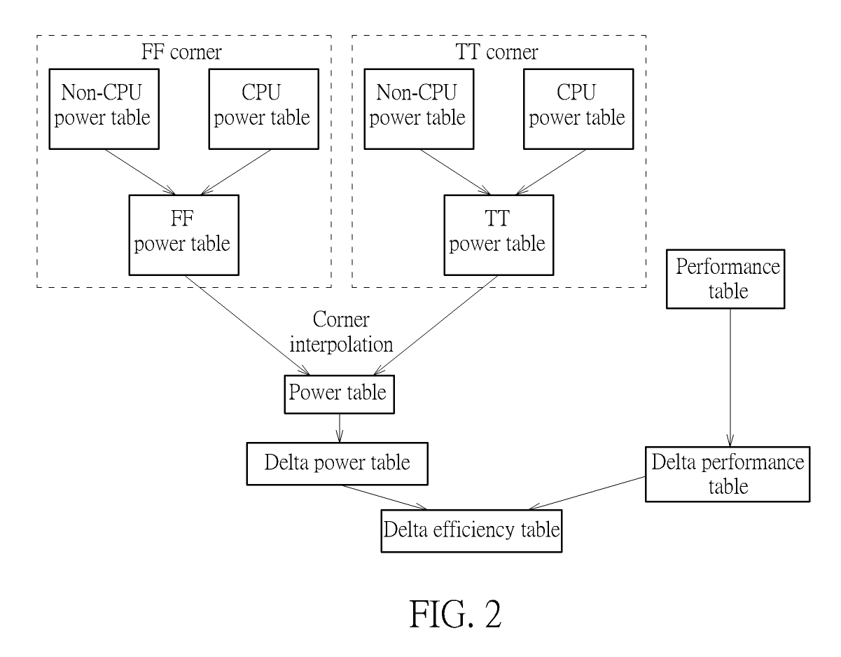

FIG. 2 is a diagram illustrating an operation of creating a delta power table and a delta efficiency table according to an embodiment of the present invention. By way of example, but not limitation, the delta power table LUT₁ and the delta efficiency table LUT₂ are computed in an offline manner, and then stored into the storage device 104 for use in the runtime power budget allocation. There may be power tables pre-built for different process corners FF and TT. As shown in FIG. 2, there are one pre-built non-CPU power table and one CPU power table for the FF corner, and there are one pre-built non-CPU power table and one CPU power table for the TT corner. Regarding each homogeneous processor core cluster, the pre-built CPU power table includes power values of different OPP settings for homogeneous processor cores (e.g., “Big (B)” processor cores, or “Middle (M)” processor cores, or “Little (L)” processor cores). Regarding each homogeneous processor core cluster, the pre-built non-CPU power table includes power values of different OPP settings for non-CPU circuitry (e.g., L2 caches) associated with the homogeneous processor cores (e.g., “Big (B)” processor cores, or “Middle (M)” processor cores, or “Little (L)” processor cores). A power table of the FF corner (denoted by “FF power table”) can be created by combining the non-CPU power table and the CPU power table pre-built for the FF corner, such that a power value recorded in the FF power table is a sum of a CPU power value and an associated non-CPU power value. Similarly, a power table of the TT corner (denoted by “TT power table”) can be created by combining the non-CPU power table and the CPU power table pre-built for the TT corner, such that a power value recorded in the TT power table is a sum of a CPU power value and an associated non-CPU power value.

Based on the known chip corner information of the multi-core processor system 12, a power table of the multi-core processor system 12 can be created by interpolation that is performed according to the FF power table and the TT power table. That is, when the chip corner of the multi-core processor system 12 is between the process corners TT and FF, the power table of the multi-core processor system 12 is set by an interpolated table that is obtained from the FF power table and the TT power table.

Consider a case where the multi-core processor system 12 has two “Big (B)” processor cores, two “Middle (M)” processor cores, and two “Little (L) ” processor cores, and “Big (B)” processor cores, “Middle (M)” processor cores, and “Little (L)” processor cores use individual buck voltages (i.e., heterogeneous processor cores of the multi-core processor system 12 do not share the same buck voltage). Hence, as to the proposed power budget allocation process, two “Big (B)” processor cores are categorized into a first cluster, two “Middle (M)” processor cores are categorized into a second cluster, and two “Little (L)” processor cores are categorized into a third cluster. The first cluster supports two core combinations, say, B*1 and B*2. The second cluster supports two core combinations, say, M*1 and M*2. The third cluster supports two core combinations, say, L*1 and L*2. The interpolated power table generated to serve as the power table of the multi-core processor system 12 may have the table contents shown in the following exemplary table.

Power table (mW)

| OPP | B*1 | B*2 | M*1 | M*2 | L*1 | L*2 |
|---|---|---|---|---|---|---|
| 0 | 2000 | 3500 | 600 | 1000 | 350 | 600 |
| 1 | 1600 | 3000 | 500 | 800 | 300 | 450 |
| 2 | 1200 | 2200 | 400 | 600 | 250 | 350 |
| 3 | 1000 | 1700 | 300 | 500 | 200 | 300 |

Generally, different OPP settings 0, 1, 2, 3 for the same cluster imply different frequency settings used. For example, the relationship between the OPP settings and the frequency settings is shown in the following exemplary table.

Frequency (GHz)

| OPP | B | M | L |
|---|---|---|---|
| 0 | 2.5 | 1.7 | 1.2 |
| 1 | 2 | 1.5 | 1 |
| 2 | 1.2 | 1 | 0.7 |
| 3 | 0.5 | 0.4 | 0.3 |

Consider another case where the multi-core processor system 12 has two “Big (B)” processor cores, two “Middle (M)” processor cores, and two “Little (L)” processor cores, and “Big (B)” processor cores use an individual buck voltage and “Middle (M)” processor cores and “Little (L)” processor cores use a shared buck voltage. Hence, as to the proposed power budget allocation process, two “Big (B)” processor cores are categorized into a first cluster, and two “Middle (M)” processor cores and two “Little (L)” processor cores are categorized into a second cluster. The first cluster supports two core combinations, say, B*1 and B*2. The second cluster supports eight (i.e., (2+1)*(2+1)−1) core combinations, say, M*0+L*1, M*0+L*2, M*1+L*0, M*1+L*1, M*1+L*2, M*2+L*0, M*2+L*1, M*2+L*2. Hence, the power table of the multi-core processor system 12 is set by an expanded power table that may be derived from expanding a portion of the above-mentioned unexpanded power table. The resulting power table may have the table contents shown in the following exemplary table.

Power table (mW)

| | | | M*0 + | M*0 + | M*1 + | M*1 + | M*1 + | M*2 + | M*2 + | M*2 + |
|---|---|---|---|---|---|---|---|---|---|---|
| OPP | B*1 | B*2 | L*1 | L*2 | L*0 | L*1 | L*2 | L*0 | L*1 | L*2 |
| 0 | 2000 | 3500 | 350 | 600 | 600 | 950 | 1200 | 1000 | 1350 | 1600 |
| 1 | 1600 | 3000 | 300 | 450 | 500 | 800 | 950 | 800 | 1100 | 1250 |
| 2 | 1200 | 2200 | 250 | 350 | 400 | 650 | 750 | 600 | 850 | 950 |
| 3 | 1000 | 1700 | 200 | 300 | 300 | 500 | 600 | 500 | 700 | 800 |

As shown in FIG. 2, a performance table may be created by obtaining performance values (i.e., benchmark scores) from a benchmark application (e.g., AnTuTu) running on the multi-core processor system 12. Consider the case where the multi-core processor system 12 has two “Big (B)” processor cores, two “Middle (M)” processor cores, and two “Little (L)” processor cores, and “Big (B)” processor cores, “Middle (M) ” processor cores, and “Little (L) ” processor cores use individual buck voltages (i.e., heterogeneous processor cores of the multi-core processor system 12 do not share the same buck voltage). The performance table may have the table contents shown in the following exemplary table.

Performance table (benchmark score)

| OPP | B*1 | B*2 | M*1 | M*2 | L*1 | L*2 |
|---|---|---|---|---|---|---|
| 0 | 2000 | 4000 | 900 | 1800 | 600 | 1200 |
| 1 | 1500 | 3000 | 700 | 1400 | 500 | 1000 |
| 2 | 1000 | 2000 | 600 | 1200 | 400 | 800 |
| 3 | 500 | 1000 | 500 | 1000 | 300 | 600 |

Consider another case where the multi-core processor system 12 has two “Big (B)” processor cores, two “Middle (M)” processor cores, and two “Little (L)” processor cores, and “Big (B)” processor cores use an individual buck voltage and “Middle (M)” processor cores and “Little (L)” processor cores use a shared buck voltage. The performance table is set by an expanded performance table that may be derived from expanding a portion of the above-mentioned unexpanded performance table. The resulting table may have the table contents shown in the following exemplary table.

Performance table (benchmark score)

| | | | M*0 + | M*0 + | M*1 + | M*1 + | M*1 + | M*2 + | M*2 + | M*2 + |
|---|---|---|---|---|---|---|---|---|---|---|
| OPP | B*1 | B*2 | L*1 | L*2 | L*0 | L*1 | L*2 | L*0 | L*1 | L*2 |
| 0 | 2000 | 4000 | 600 | 1200 | 900 | 1500 | 2100 | 1800 | 2400 | 3000 |
| 1 | 1500 | 3000 | 500 | 1000 | 700 | 1200 | 1700 | 1400 | 1900 | 2400 |
| 2 | 1000 | 2000 | 400 | 800 | 600 | 1000 | 1400 | 1200 | 1600 | 2000 |
| 3 | 500 | 1000 | 300 | 600 | 500 | 800 | 1100 | 1000 | 1300 | 1600 |

After the power table is obtained, a delta power table can be created by calculating a delta power value between power values corresponding to adjacent OPP settings. For example, a delta power value DP_{K→K+1} corresponding to an OPP transition OPP_{K}→OPP_{K+1} of one core combination in one cluster is calculated by subtracting a power value P_{K+1} corresponding to the OPP setting OPP_{K+1} from a power value P_{K} corresponding to the OPP setting OPP_{K}. That is, DP_{K>K+1}=P_{K}−P_{K+1}. If the OPP setting OPP_{K} is OPP 0, the OPP setting OPP_{K+1} is OPP 1. If the OPP setting OPP_{K} is OPP 1, the OPP setting OPP_{K+1} is OPP 2. If the OPP setting OPP_{K} is OPP 2, the OPP setting OPP_{K+1} is OPP 3. When the hotplug function is considered by allocation of the power budget, there is one OPP transition between a minimum frequency setting and disabling one processor core (e.g., OPP transition=“3-OFF”).

After the performance table is obtained, a delta performance table can be created by calculating a delta performance value between performance values corresponding to adjacent OPP settings. For example, a delta performance value DPF_{K>K+1} corresponding to an OPP transition OPP_{K}→OPP_{K+1} of one core combination in one cluster is calculated by subtracting a performance value PF_{K+1} corresponding to the OPP setting OPP_{K+1} from a performance value PF_{K} corresponding to the OPP setting OPP_{K}. That is, DPF_{K→K+1}=PF_{K}-PF_{K+1}. If the OPP setting OPP_{K} is OPP 0, the OPP setting OPP_{K+1} is OPP 1. If the OPP setting OPP_{K} is OPP 1, the OPP setting OPP_{K+1} is OPP 2. If the OPP setting OPP_{K} is OPP 2, the OPP setting OPP_{K+1} is OPP 3. When the hotplug function is considered by allocation of the power budget, there is one OPP transition between a minimum frequency setting and disabling one processor core (e.g., OPP transition=“3-OFF”).

Consider a case where the multi-core processor system 12 has two “Big (B)” processor cores, two “Middle (M)” processor cores, and two “Little (L)” processor cores, and “Big (B)” processor cores use an individual buck voltage and “Middle (M)” processor cores and “Little (L)” processor cores use a shared buck voltage. The delta power table is derived from an expanded power table, and the delta performance table is derived from an expanded performance table. The delta power table and delta performance table may have the table contents shown in the following exemplary tables.

Delta power table (mW)

| | | | M*0 + | M*0 + | M*1 + | M*1 + | M*1 + | M*2 + | M*2 + | M*2 + |
|---|---|---|---|---|---|---|---|---|---|---|
| OPP | B*1 | B*2 | L*1 | L*2 | L*0 | L*1 | L*2 | L*0 | L*1 | L*2 |
| 0-1 | 400 | 500 | 50 | 150 | 100 | 150 | 250 | 200 | 250 | 350 |
| 1-2 | 400 | 800 | 50 | 100 | 100 | 150 | 200 | 200 | 250 | 300 |
| 2-3 | 200 | 500 | 50 | 50 | 100 | 150 | 150 | 100 | 150 | 150 |
| 3-OFF | 1000 | 700 | 200 | 100 | 300 | 300 | 300 | 200 | 200 | 200 |

| | | |
|---|---|---|
| Off 1 B | Off 1 L | Off 1 M Core |
| Core | Core | |

Delta performance table (benchmark score)

| | | | M*0 + | M*0 + | M*1 + | M*1 + | M*1 + | M*2 + | M*2 + | M*2 + |
|---|---|---|---|---|---|---|---|---|---|---|
| OPP | B*1 | B*2 | L*1 | L*2 | L*0 | L*1 | L*2 | L*0 | L*1 | L*2 |
| 0-1 | 500 | 1000 | 100 | 200 | 200 | 300 | 400 | 400 | 500 | 600 |
| 1-2 | 500 | 1000 | 100 | 200 | 100 | 200 | 300 | 200 | 300 | 400 |
| 2-3 | 500 | 1000 | 100 | 200 | 100 | 200 | 300 | 200 | 300 | 400 |
| 3-OFF | 500 | 500 | 300 | 300 | 500 | 500 | 500 | 500 | 500 | 500 |

| | | |
|---|---|---|
| Off 1 B | Off 1 L Core | Off 1 M Core |
| Core | | |

After the delta power table and delta performance table are both obtained, a delta efficiency table can be created by calculating a delta power efficiency value according to a delta power value obtained from the delta power table and a delta performance value obtained from the delta performance table, where

$$delta power efficiency value = \frac{delta performance value}{delta power value} .$$

For example, a delta power efficiency value DPE_{K→K+1} corresponding to an OPP transition OPP_{K}→OPP_{K+1} of one core combination in one cluster is calculated through dividing a delta performance value DPF_{K→K+1} by a delta power value DP_{K→K+1}. That is, DPE_{K→K+1}=DPF_{K→K+1}/DP_{K→K+1}. When the hotplug function is considered by allocation of the power budget, there is one OPP transition between a minimum frequency setting and disabling one processor core (e.g., OPP transition=37 3−OFF”). The delta efficiency table may have the table contents shown in the following exemplary table.

Delta efficiency table (benchmark score/mW)

| | | | M*0 + | M*0 + | M*1 + | M*1 + | M*1 + | M*2 + | M*2 + | M*2 + |
|---|---|---|---|---|---|---|---|---|---|---|
| OPP | B*1 | B*2 | L*1 | L*2 | L*0 | L*1 | L*2 | L*0 | L*1 | L*2 |
| 0-1 | 1.3 | 2.0 | 2.0 | 1.3 | 2.0 | 2.0 | 1.6 | 2.0 | 2.0 | 1.7 |
| 1-2 | 1.3 | 1.3 | 2.0 | 2.0 | 1.0 | 1.3 | 1.5 | 1.0 | 1.2 | 1.3 |
| 2-3 | 2.5 | 2.0 | 2.0 | 4.0 | 1.0 | 1.3 | 2.0 | 2.0 | 2.0 | 2.7 |
| 3-OFF | 0.5 | 0.7 | 1.5 | 3.0 | 1.7 | 1.7 | 1.7 | 2.5 | 2.5 | 2.5 |

| | | |
|---|---|---|
| Off 1 B | Off 1 L Core | Off 1 M Core |
| Core | | |

Consider another case where the multi-core processor system 12 has two “Big (B)” processor cores, two “Middle (M)” processor cores, and two “Little (L)” processor cores, and “Big (B)” processor cores, “Middle (M)” processor cores, and “Little (L)” processor cores use individual buck voltages (i.e., heterogeneous processor cores of the multi-core processor system 12 do not share the same buck voltage). The delta power table, the delta performance table and the delta efficiency table can be obtained according to the non-bulk-voltage-shared power table and the non-bulk-voltage-shared performance table. Since the computation of delta power values, delta performance value and delta efficiency values according to the non-bulk-voltage-shared power table and the non-bulk-voltage-shared performance table is same as the computation of delta power values, delta performance value and delta efficiency values according to the bulk-voltage-shared power table and the bulk-voltage-shared performance table, further description is omitted here for brevity.

It should be noted that when the hotplug function is not considered by allocation of the power budget due to long core-off latency, the table entry associated with the OPP transition between a minimum frequency setting and disabling one processor core (e.g., OPP transition=37 3-OFF”) may be omitted from each of the delta power table, the delta performance table and the delta efficiency table. However, this is for illustrative purposes only, and is not meant to be a limitation of the present invention.

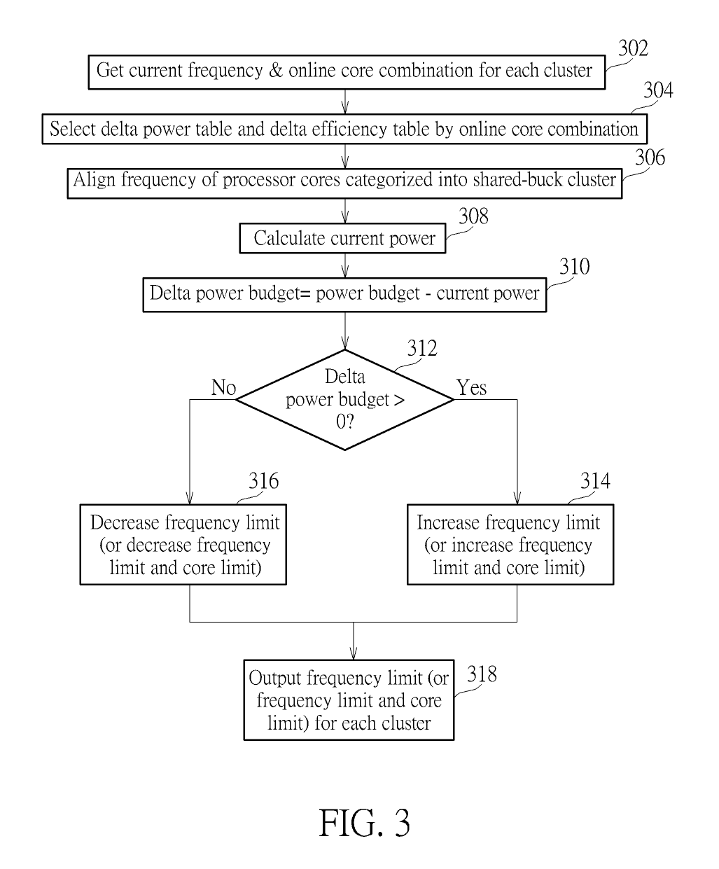

After the delta power table and the delta efficiency table are obtained, the delta power table and the delta efficiency table are stored into the storage device 104 to serve as power management tables (e.g, LUT₁ and LUT₂) that will be used by the power management controller 102 for allocation of the power budget P_{BA} decided by the thermal/power throttle controller 16. FIG. 3 is a flowchart illustrating a power budget allocation method according to an embodiment of the present invention. The power budget allocation method may be employed by the power management controller 102. Provided that the result is substantially the same, the steps are not required to be executed in the exact order shown in FIG. 3.

In this embodiment, the system setting INF_{SYS} is a runtime system setting currently employed by the multi-core processor system 12. At step 302, the power management controller 102 gets the system setting INF_{SYS} from the DVFS & hotplug circuit 18, wherein the system setting INF_{SYS} includes a core combination setting (e.g., an on-line core combination) of multi-core processor system 12 and a frequency setting (e.g., a current frequency) of each processor core selected by the core combination setting of multi-core processor system 12. The on-line core combination is composed of processor cores currently enabled in the multi-core processor system 12. Hence, the allocation of the power budget P_{BG} is needed to be applied to at least the processor cores currently enabled in the multi-core processor system 12 for frequency limit determination and/or online core limit determination. At step 304, the power management controller 102 selects a partial delta power table from the delta power table according to the core combination setting included in the system setting SYS_{INF}, and further selects a partial delta efficiency table from the delta efficiency table according to the core combination setting included in the system setting SYS_{INF}. For example, when the core combination setting included in the system setting SYS_{INF} indicates that the online core combination is composed of two “Big” processor cores and four “Little” processor cores (i.e., B*2+L*4), a partial delta power table, including delta power values of different OPP transitions of the core combination B*2 of the “Big” processor core cluster and delta power values of different OPP transitions of the core combination L*4 of the “Little” processor core cluster, is read from the storage device 104 and loaded into the power management controller 102, and a partial delta efficiency table, including delta power efficiency values of different OPP transitions of the core combination B*2 of the “Big” processor core cluster and delta power efficiency values of different OPP transitions of the core combination L*4 of the “Little” processor core cluster, is read from the storage device 104 and loaded into the power management controller 102.

At step 306, the power management controller 102 aligns frequencies of processor cores categorized into a buck-voltage-shared cluster. As mentioned above, the system setting INF_{SYS} is a runtime system setting currently employed by the multi-core processor system 12. Hence, the system setting INF_{SYS} includes a frequency setting (e.g., a current frequency) of each processor core selected by a core combination setting (e.g., an on-line core combination) of the multi-core processor system 12. For example, the multi-core processor system 12 includes “Big” processor cores, “Middle” processor cores, and “Little” processor cores. Hence, under one operational scenario, the DVFS function of the DVFS & hotplug circuit 18 may assign a first frequency to online “Big” processor cores, assign a second frequency to online “Middle” processor cores, and assign a third frequency to online “Little” processor cores. In a case where the “Middle” processor cores and the “Little” processor cores share the same buck voltage, an online “Middle” processor core and an online “Little” processor core operating under the same buck voltage may have different power consumption due to different frequencies. When the power management controller 102 performs the power budget allocation, the online “Middle” processor cores and the online “Little” processor cores are treated as having the same frequency under the same buck voltage. For example, the power management controller 102 categorizes the online “Middle” processor cores and the online “Little” processor cores into processor cores of the same cluster, and treats the online “Middle” processor cores and the online “Little” processor cores as online processor cores using the same current frequency (e.g., one of the second frequency and the third frequency).

At step 308, the power management controller 102 calculates the current power according to information given from the system setting INF_{SYS}. For example, considering a case where the multi-core processor system 12 includes “Big” processor cores, “Middle” processor cores, and “Little” processor cores using individual buck voltages, the core combination setting (e.g., an on-line core combination) and a frequency setting (e.g., a current frequency) of each processor core selected by the core combination setting are referenced by the power management controller 102 to search an unexpanded power table for power values associated with online processor cores, and then the found power values are used by the power management controller 102 to calculate the current power of the online processor cores.

For another example, considering a case where the multi-core processor system 12 includes “Big” processor cores, “Middle” processor cores and “Little” processor cores and the “Middle” processor cores and the “Little” processor cores share the same buck voltage, the core combination setting (e.g., an on-line core combination) and a frequency setting (e.g., a “Big” core frequency or an aligned “Middle” and “Little” core frequency) of each processor core selected by the core combination setting are referenced by the power management controller 102 to search an expanded power table for power values associated with online processor cores, and then the found power values are used by the power management controller 102 to calculate the current power of the online processor cores.

At step 310, the power management controller 102 calculates a delta power budget by subtracting the current power (which is calculated at step 308) from the target power budget P_{BG} (which is decided by the thermal/power throttle controller 16). Next, the power management controller 102 refers to the delta power budget to determine how to proceed with the following power budget allocation process. At step 312, the power management controller 102 checks if the delta power budget is a positive value. When the delta power budget is a positive value, it means there is room for a higher frequency and/or more online cores. Hence, the flow proceeds with step 314 to increase the frequency limit L_{FREG} (or increase the frequency limit L_{FREG} and the online core limit L_{CORE}) for one or more clusters. When the delta power budget is a negative value, it means there is a demand for a lower frequency and/or fewer online cores. Hence, the flow proceeds with step 316 to decrease the frequency limit L_{FREG} (or decrease the frequency limit L_{FREG} and the online core limit L_{CORE}) for one or more clusters. At step 318, the power management controller 102 outputs the final frequency limit L_{FREG} (or the final frequency limit L_{FREG} and online core limit L_{CORE}) found by the power budget allocation process for each cluster. Further details of steps 314 and 316 are described as below.

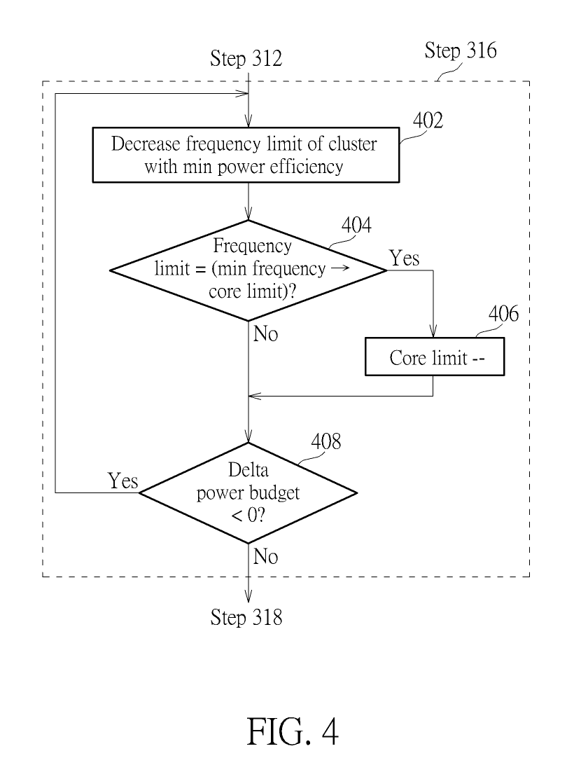

FIG. 4 is a flowchart illustrating sub-steps included in the step 316 shown in FIG. 3. Provided that the result is substantially the same, the steps are not required to be executed in the exact order shown in FIG. 4. The start points of the partial delta power table and the partial delta efficiency table selected by the power management controller 102 at step 304 are initialized on the basis of original/aligned frequencies of core combinations associated with the clusters into which the processor cores of the multi-core processor system 12 are categorized. In other words, concerning the power budget allocation process, the currently selected frequency settings of core combinations associated with clusters are initialized on the basis of original/aligned frequencies of the core combinations associated with the clusters into which the processor cores of the multi-core processor system 12 are categorized. Moreover, concerning the power budget allocation process, currently selected online core settings of core combinations associated with clusters are initialized by the core combinations, respectively.

For example, considering a case where the multi-core processor system 12 includes “Big” processor cores, “Middle” processor cores, and “Little” processor cores using individual buck voltages, a current frequency of online “Big” processor cores is used to initialize a currently selected frequency setting of a core combination (e.g., B*2) associated with the “Big” core cluster, a current frequency of online “Middle” processor cores is used to initialize a currently selected frequency setting of a core combination (e.g., M*1) associated with the “Middle” core cluster, a current frequency of online “Little” processor cores is used to initialize a currently selected frequency setting of a core combination (e.g., L*2) associated with the “Little” core cluster, a combination of the online “Big” processor cores (e.g., B*2) is used to initialize a currently selected online core setting of the “Big” core cluster, a combination of the online “Middle” processor cores (e.g., M*1) is used to initialize a currently selected online core setting of the “Middle” core cluster, and a combination of the online “Little” processor cores (e.g., L*2) is used to initialize a currently selected online core setting of the “Little” core cluster. The currently selected frequency setting and/or the currently selected online core setting of at least one cluster (e.g., “Big” core cluster, “Middle” core cluster, and/or “Little” core cluster) may be adjusted/updated by the power budget allocation performed by the power management controller 102.

For another example, considering a case where the multi-core processor system 12 includes “Big” processor cores, “Middle” processor cores and “Little” processor cores and the “Middle” processor cores and the “Little” processor cores share the same buck voltage, a current frequency of online “Big” processor cores is used to initialize a currently selected frequency setting of a core combinations (e.g., B*2) associated with the “Big” core cluster, an aligned frequency of online “Middle” processor cores and online “Little” processor cores is used to initialize a currently selected frequency setting of core combinations (e.g., M*1+L*2) associated with the “Middle” and “Little” core cluster, a combination of the online “Big” processor cores (e.g., B*2) is used to initialize a currently selected online core setting of the “Big” core cluster, and a combination of the online “Middle” processor cores and the online “Little” processor cores (e.g., M*1+L*2) is used to initialize a currently selected online core setting of the “Middle” and “Little” core cluster. The currently selected frequency setting and/or the currently selected online core setting of at least one cluster (e.g., “Big” core cluster and/or “Middle” and “Little” core cluster) may be adjusted/updated by the power budget allocation performed by the power management controller 102.

At step 402, the power management controller 102 compares delta power efficiency values associated with candidate OPP transitions to find a minimum delta power efficiency value, wherein the candidate OPP transitions correspond to currently selected frequency settings of specific core combinations of different clusters, and the specific core combinations of the different clusters are selected by the core combination setting included in the system setting INF_{SYS}. If the selected candidate OPP transition with the minimum delta power efficiency value is not the OPP transition “4-OFF”, the power management controller 102 changes a currently selected frequency setting of a specific cluster with the minimum delta power efficiency value such that a frequency limit of the specific cluster is decreased (Step 402). In addition, the delta power budget is updated correspondingly by adding a delta power value associated with the selected candidate OPP transition to the current delta power budget (i.e., delta power budget+=delta power value associated with the selected candidate OPP transition).

If the candidate OPP transition with the minimum delta power efficiency value is the OPP transition “4-OFF”, the power management controller 102 changes a currently selected online core setting of a specific cluster with the minimum delta power efficiency value such that an online core limit (i.e., an online core number) of the specific cluster is decreased (Steps 404 and 406), where the currently selected frequency setting of the specific cluster is kept at OPP=4 (minimum frequency). In addition, the delta power budget is updated by adding a delta power value associated with the selected candidate OPP transition to the current delta power budget (i.e., delta power budget+=delta power value associated with the selected candidate OPP transition).

At step 408, the power management controller 102 checks if the updated delta power budget is still a negative value. If the updated delta power budget is still a negative value, the next iteration of decreasing the frequency/core limit is performed based on comparison of delta power efficiency values associated with candidate OPP transitions corresponding to currently selected frequency settings of clusters. If the updated delta power budget is not a negative value, the step 316 performed for decreasing the frequency limit (or the frequency limit and the core limit) is completed.

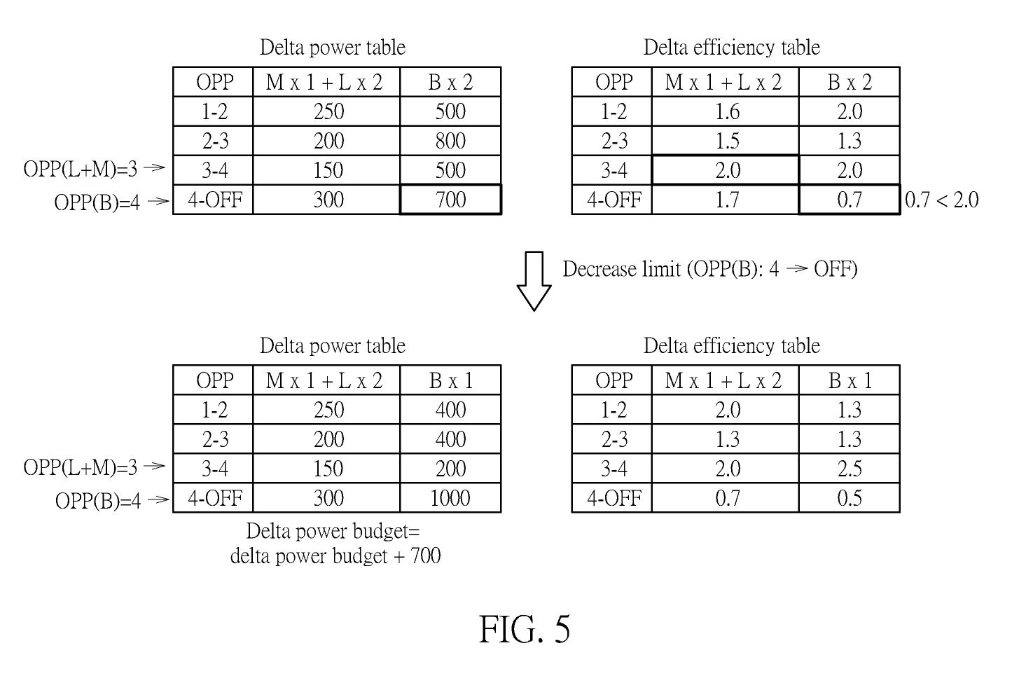

FIG. 5 is a diagram illustrating an example of decreasing an operation limit (e.g., a core limit L_{CORE}) of a cluster according to the step 316 shown in FIG. 4. Consider a case where the multi-core processor system 12 includes “Big” processor cores, “Middle” processor cores and “Little” processor cores and the “Middle” processor cores and the “Little” processor cores share the same buck voltage. Hence, processor cores of the multi-core processor system 12 are categorized into a cluster B (which includes “Big” processor cores) and a cluster L+M (which includes “Middle” processor cores and “Little” processor cores). Suppose that the system setting INF_{SYS} indicates that a core combination M*1+L*2 associated with the cluster L+M is selected, and a core combination B*2 associated with the cluster B is selected; the system setting INF_{SYS} further indicates that the frequency of the online “Big” processor cores B*2 is set by OPP=4, the frequency of the online “Middle” processor core M*1 is set by OPP=3, and the frequency of the online “Little” processor cores L*2 is set by OPP=2; and the power management controller 102 aligns the frequency of the online “Middle” processor core M*1 and the frequency of the online “Little” processor cores L*2 by OPP=3. As shown in FIG. 5, under the frequency/core limit decrease scenario, the currently selected frequency setting of the core combination M*1+L*2 associated with the cluster L+M is initialized by OPP=3, and the currently selected frequency setting of the core combination B*2 associated with the cluster B is initialized by OPP=4, such that the candidate OPP transition corresponding to OPP (B)=4 is the OPP transition “4-OFF”, and the candidate OPP transition corresponding to OPP(L+M)=3 is the OPP transition “3-4”. Since the delta power efficiency value associated with the OPP transition “4-OFF” is smaller than the delta power efficiency value associated with the OPP transition “3-4”, the OPP transition “4-OFF” is selected by the current iteration of decreasing the frequency/core limit. Hence, the currently selected online core setting B*2 of the cluster B is changed to B*1 for reflecting “one core off”. In this example, the currently selected frequency setting of the cluster B is kept at OPP=4 due to the face that the cluster B still has one online processor core according to the currently selected online core setting B*1.

In addition, since the delta power value associated with the selected OPP transition “4-OFF” for the cluster B is 700, the delta power budget is updated by adding 700 to the current delta power budget. It should be noted that, since the currently selected online core setting for the cluster B is B*1, delta power values of different OPP transitions of the core combination B*1 are loaded for the following power budget allocation process, and delta efficiency values of different OPP transitions of the core combination B*1 are loaded for the following power budget allocation process. If the updated delta power budget is still a negative value, the next iteration of decreasing the frequency/core limit is performed based on comparison of delta power efficiency values associated with candidate OPP transitions “3-4” and “4-OFF” corresponding to currently selected frequency settings OPP(L+M)=3 and OPP (B)=4 of clusters L+M and B.

It should be noted that, if a cluster has no online processor core due to a currently selected online core setting decreased to 0 by iteration(s) of decreasing the frequency/core limit, the cluster is not considered by following iteration(s) of decreasing the frequency/core limit.

As mentioned above, selecting one OPP transition from a plurality of candidate OPP transitions for decreasing the online core limit depends on a comparison result of delta efficiency values associated with the candidate OPP transitions. In general, the latency of turning off one processor core is longer than that of changing the frequency of one processor core. As a result, the long core-off latency may degrade the thermal control performance. To reduce the possibility of selecting the OPP transition between the minimum frequency and disabling one processor core during the power budget allocation process, the present invention further proposes adjusting the delta efficiency table to increase a delta efficiency value associated with the OPP transition between the minimum frequency and disabling one processor core. For example, the delta efficiency table shown in FIG. 5 maybe adjusted to multiply the delta efficiency value associated with the OPP transition “4-OFF” of the core combination B*2 of the cluster B by a predetermined value (e.g., 10), and/or may be adjusted to multiply the delta efficiency value associated with the OPP transition “4-OFF” of the core combination M*1+L*2 of the cluster L+M by the predetermined value (e.g., 10). Hence, the adjusted delta efficiency table may have the table contents shown as below.

Delta efficiency table

| OPP | B*2 | M*1 + L*2 |
|---|---|---|
| 1-2 | 2.0 | 1.6 |
| 2-3 | 1.3 | 1.5 |
| 3-4 | 2.0 | 2.0 |
| 4-OFF | 7 (0.7 * 10) | 17 (1.7 * 10) |

As mentioned above, selecting one OPP transition from a plurality of candidate OPP transitions for decreasing the frequency limit depends on a comparison result of delta power efficiency values associated with the candidate OPP transitions. However, it is possible that changing the frequency of one processor core according to an OPP setting included in a particular OPP transition may suffer from long latency, thus resulting in degraded thermal control performance. To reduce the possibility of selecting the particular OPP transition during the power budget allocation process, the present invention further proposes adjusting the delta efficiency table to increase a delta efficiency value associated with the particular OPP transition. For example, the delta efficiency table shown in FIG. 5 maybe adjusted to multiply the delta efficiency value associated with the long-latency OPP transition “3-4” of the core combination B*2 of the cluster B by a predetermined value (e.g., 10). Hence, the adjusted delta efficiency table may have the table contents shown as below.

Delta efficiency table

| OPP | B*2 | M*1 + L*2 |
|---|---|---|
| 1-2 | 2.0 | 1.6 |
| 2-3 | 1.3 | 1.5 |
| 3-4 | 20 (2.0 * 10) | 2.0 |
| 4-OFF | 7 | 1.7 |

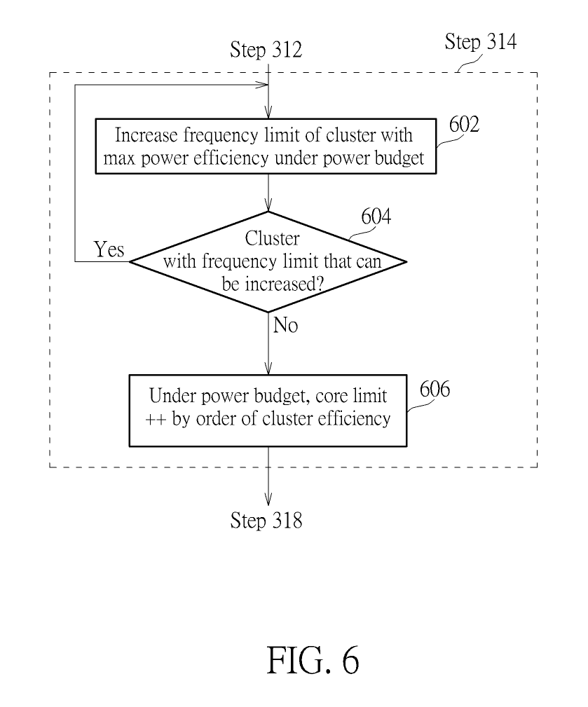

FIG. 6 is a flowchart illustrating sub-steps included in the step 314 shown in FIG. 3. Provided that the result is substantially the same, the steps are not required to be executed in the exact order shown in FIG. 6. As mentioned above, the start points of the partial delta power table and the partial delta efficiency table selected by the power management controller 102 at step 304 are initialized on the basis of original/aligned frequencies of the core combinations associated with the clusters into which the processor cores of the multi-core processor system 12 are categorized. In other words, currently selected frequency settings of core combinations associated with clusters are initialized on the basis of original/aligned frequencies of the core combinations associated with the clusters into which the processor cores of the multi-core processor system 12 are categorized. Moreover, currently selected online core settings of core combinations associated with clusters are initialized by the core combinations, respectively.

At step 602, the power management controller 102 compares delta power efficiency values associated with candidate OPP transitions to find a maximum delta power efficiency value under the target power budget (i.e., a delta power value associated with a found maximum delta power efficiency value is not larger than the current delta power budget), wherein the candidate OPP transitions correspond to currently selected frequency settings of specific core combinations of the clusters, and the specific core combinations of the clusters are selected by the core combination setting included in the system setting INF_{SYS}. The power management controller 102 changes a currently selected frequency setting of a specific cluster with the maximum delta power efficiency value such that a frequency limit of the specific cluster is increased, wherein the delta power budget is updated by subtracting a delta power value associated with the selected candidate OPP transition from the current delta power budget.

Step 602 may be performed iteratively to increase the frequency limit of the same cluster or increase frequency limits of different clusters, depending upon comparison results of delta power efficiency values that are obtained in different iterations. When the currently selected frequency settings of core combinations associated with the clusters are all maximum frequency settings, implying that no frequency limit of each cluster can be increased (step 604), the operation of increasing the core limit of at least one cluster under the target power budget (i.e., a delta power value associated with enabling one processor core operating under a minimum frequency is not larger than the current delta power budget) may be performed (Step 606). In this embodiment, increasing the core limit of at least one cluster under the target power budget may be performed according to the order of cluster efficiency (e.g., L→M→B for a non-buck-voltage-sharing case, or (L+M)→B for a buck-voltage-sharing case), where the at least one cluster has at least one offline processor core. Hence, when the currently selected frequency settings of clusters M and L are all maximum frequency settings (or the currently selected frequency setting of the cluster M+L is a maximum frequency setting) and a delta power value associated with enabling one “Big” processor core operating under a minimum frequency is not larger than the current delta power budget, the currently selected online core setting of the cluster B is changed for increasing the online core limit of the cluster B.

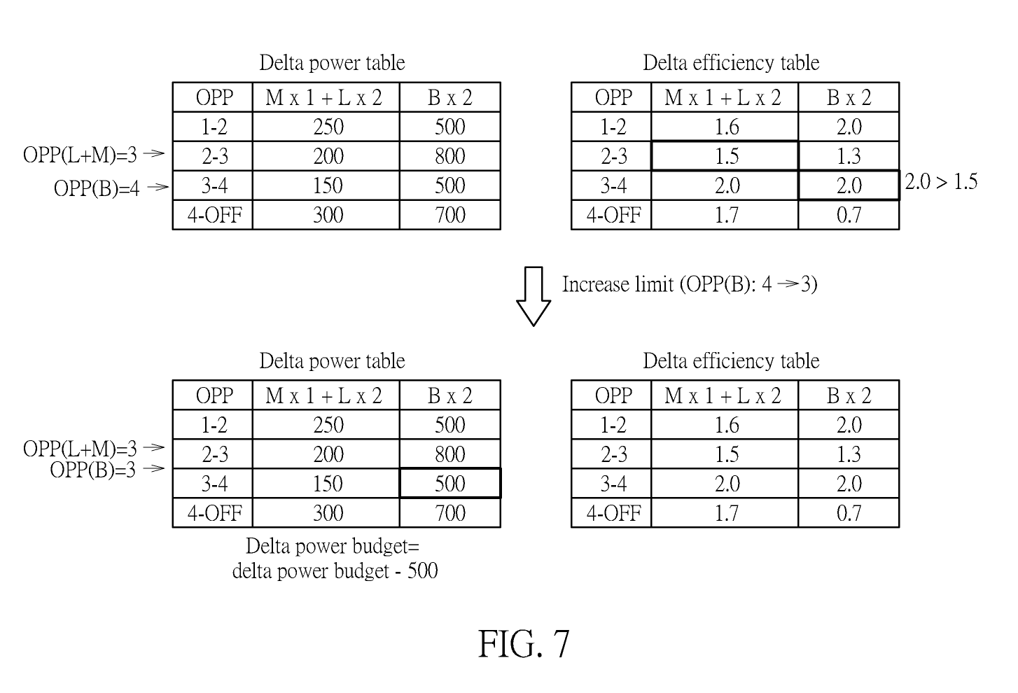

FIG. 7 is a diagram illustrating an example of increasing an operation limit (e.g., a frequency limit L_{FREQ}) of a cluster according to the step 314 shown in FIG. 6. Consider a case where the multi-core processor system 12 includes “Big” processor cores, “Middle” processor cores and “Little” processor cores and the “Middle” processor cores and the “Little” processor cores share the same buck voltage. Hence, processor cores of the multi-core processor system 12 are categorized into a cluster B (which includes “Big” processor cores) and a cluster L+M (which includes “Middle” processor cores and “Little” processor cores). Suppose that the system setting INF_{SYS} indicates that a core combination M*1+L*2 associated with the cluster L+M is selected, and a core combination B*2 associated with the cluster B is selected; the system setting INF_{SYS} further indicates that the frequency of the online “Big” processor cores B*2 is set by OPP=4, the frequency of the online “Middle” processor core M*1 is set by OPP=3, and the frequency of the online “Little” processor cores L*2 is set by OPP=2; and the power management controller 102 aligns the frequency of the online “Middle” processor core M*1 and the frequency of the online “Little” processor cores L*2 by OPP=3. As shown in FIG. 7, under the frequency/core limit increase scenario, the currently selected frequency setting of the core combination M*1+L*2 associated with the cluster L+M is initialized by OPP=3, and the currently selected frequency setting of the core combination B*2 associated with the cluster B is initialized by OPP=4, such that the candidate OPP transition corresponding to OPP (B)=4 is the OPP transition “3-4”, and the candidate OPP transition corresponding to OPP (L+M)=3 is the OPP transition “2-3”. Since the delta power efficiency value associated with the OPP transition “3-4” is larger than the delta power efficiency value associated with the OPP transition “2-3”, and the delta power value associated with the maximum OPP transition “3-4” is not larger than the current delta power budget, the maximum OPP transition “3-4” is selected by the current iteration of increasing the frequency/core limit, and the currently selected frequency setting of the cluster B is changed to OPP=3. In addition, the delta power budget is updated by subtracting 500 from the current delta power budget. If the updated delta power budget is still a positive value, the next iteration of increasing the frequency/core limit is performed based on comparison of delta power efficiency values associated with candidate OPP transitions “2-3” corresponding to currently selected frequency settings OPP (L+M)=3 and OPP (B)=3 of clusters L+M and B. If the currently selected frequency settings of clusters L+M and B are all OPP=1 (maximum frequency), the operation of increasing the core limit of at least one cluster under the target power budget may be performed.

As mentioned above, selecting one OPP transition from a plurality of candidate OPP transitions for increasing the frequency limit depends on a comparison result of delta efficiency values associated with the candidate OPP transitions. However, it is possible that changing the frequency of one processor core according to an OPP setting included in a particular OPP transition may suffer from long latency, thus resulting in degraded thermal control performance. To reduce the possibility of selecting the particular OPP transition during the power budget allocation process, the present invention further proposes adjusting the delta efficiency table to decrease a delta efficiency value associated with the particular OPP transition. For example, the delta efficiency table shown in FIG. 5 may be adjusted to divide the delta efficiency value associated with the long-latency OPP transition “2-3” of the core combination B*2 of the cluster B by a predetermined value (e.g., 10). Hence, the adjusted delta efficiency table may have the table contents shown as below.

Delta efficiency table

| OPP | B*2 | M*1 + L*2 |
|---|---|---|
| 1-2 | 2.0 | 1.6 |
| 2-3 | 0.13 (1.3/10) | 1.5 |
| 3-4 | 2.0 | 2.0 |
| 4-OFF | 0.7 | 1.7 |

With regard to the frequency/core limit increase case or the frequency/core limit decrease case, if there is a need to skip/omit a given OPP setting, the delta power table and the delta efficiency table can be properly adjusted to achieve this goal. For example, if the OPP setting OPP=2 of the core combination B*2 of the cluster B is desired to be skipped/omitted, the OPP setting is switched between OPP=1 and OPP=3. The delta power efficiency value associated with the OPP transition “1-2” shown in FIG. 5 may be set by an equivalent delta power efficiency value associated with an OPP transition “1-3”, and the delta power efficiency value associated with the OPP transition “2-3” shown in FIG. 5 may be set by the same equivalent delta power efficiency value associated with the OPP transition “1-3”. For example, the equivalent delta power efficiency value associated with the OPP transition “1-3” may be derived from dividing a delta performance value associated with the OPP transition “1-3” by a delta power value associated with the OPP transition “1-3”. In addition, the delta power value associated with the OPP transition “1-2” shown in FIG. 5 may be set by a zero value, and the delta power value associated with the OPP transition “2-3” shown in FIG. 5 may be set by an equivalent delta power value associated with an OPP transition “1-3”. For example, the equivalent delta power value associated with the OPP transition “1-3” may be a sum of the delta power value associated with the OPP transition “1-2” and the delta power value associated with the OPP transition “2-3”. Hence, the adjusted delta power table and the adjusted delta efficiency table may have the table contents shown as below.

Delta power table

| OPP | B*2 | M*1 + L*2 |
|---|---|---|
| 1-2 | 0 | 250 |
| 2-3 | 1300 (500 + 800) | 200 |
| 3-4 | 500 | 150 |
| 4-OFF | 700 | 300 |

Delta efficiency table

| OPP | B*2 | M*1 + L*2 |
|---|---|---|
| 1-2 | 1.6 | 1.6 |
| 2-3 | 1.6 | 1.5 |
| 3-4 | 2.0 | 2.0 |
| 4-OFF | 0.7 | 1.7 |

In above embodiments, a delta power table and a delta efficiency table are stored in the storage device 104 to serve as power management tables (e.g., LUT₁ and LUT₂) that will be used by the power management controller 102 for allocation of the power budget P_{BA} decided by the thermal/power throttle controller 16. However, this is for illustrative purposes only, and is not meant to be a limitation of the present invention. In an alternative design, a single table may be stored in the storage device 104 to serve as one power management table that will be used by the power management controller 102 for allocation of the power budget P_{BA} decided by the thermal/power throttle controller 16. The multi-core processor system 12 has a plurality of processor cores supporting a plurality of core combinations. For example, considering a case where the multi-core processor system 12 has two “Big” processor cores, 4 “Middle” processor cores and 4 “Little” processor cores, the multi-core processor system 12 may support [(2+1)*(4+1)*(4+1)−1] core combinations. Regarding each of [(2+1)*(4+1)*(4+1)−1] core combinations, the single table records a plurality of power budget values associated with different OPP combinations, respectively, and further records a plurality of performance values associated with the different OPP combinations, respectively.

Suppose that the multi-core processor system 12 has two “Big” processor cores, two “Middle” processor cores, and two “Little” processor cores. The multi-core processor system 12 supports [(2+1)*(2+1)*(2+1)−1] core combinations, including [B*1, M*0, L*0] . . . [B*2, M*2, L*2]. The single table stored in the storage device 104 may have the table contents shown as below.

| OPP combination | | | | Power |
|---|---|---|---|---|
| B OPP limit | M OPP limit | L OPP limit | Performance | budget |

B*1 M*0 L*0

| | | | | |
|---|---|---|---|---|
| 0 | X | X | 2000 | 2000 |
| 1 | X | X | 1500 | 1600 |
| 2 | X | X | 1000 | 1200 |
| 3 | X | X | 500 | 1000 |

. . .
B*2 M*2 L*2

| | | | | |
|---|---|---|---|---|
| 0 | 0 | 0 | 7000 | 5100 |
| 0 | 1 | 1 | 6400 | 4750 |
| 1 | 0 | 0 | 6000 | 4600 |
| . . . | . . . | . . . | . . . | . . . |

The power management controller 102 selects a partial table from the single table stored in the storage device 104 according to the core combination setting included in the system setting SYS_{INF}. For example, when the core combination setting included in the system setting SYS_{INF} indicates that the online core combination is [B*2, M*2, L*2], the partial table associated with the online core combination [B*2, M*2, L*2] is selected and used by the power management controller 102 for allocation of the target power budget P_{BG} decided by the thermal/power throttle controller 16. The power management controller 102 checks the selected partial table associated with the online core combination [B*2, M*2, L*2] to find an OPP combination associated with a maximum performance value under the target power budget P_{BG}. Suppose that the target power budget P_{BG} is 4800. Among OPP combinations of the online core combination [B*2, M*2, L*2] that are associated with power values each being smaller than 4800, the OPP combination [0, 1, 1] is associated with the maximum performance value 6400. The frequency limit L_{FREQ} for each of the clusters B, M, L is set according to the selected OPP combination [0, 1, 1] correspondingly.

In above embodiments, the power management controller 102 is configured to provide a frequency limit L_{FREQ} (or a frequency limit L_{FREQ} and an online core limit L_{CORE}) to the DVFS & hotplug circuit 18, such that the DVFS & hotplug circuit 18 refers to the frequency limit L_{FREQ} (or the frequency limit L_{FREQ} and the online core limit L_{CORE}) to determine a frequency setting of each processor core under the frequency constraint (or determine a frequency setting of each processor core under the frequency constraint and select a core combination setting of the multi-core processor system 12 under the online core constraint). However, this is for illustrative purposes only, and is not meant to be a limitation of the present invention.

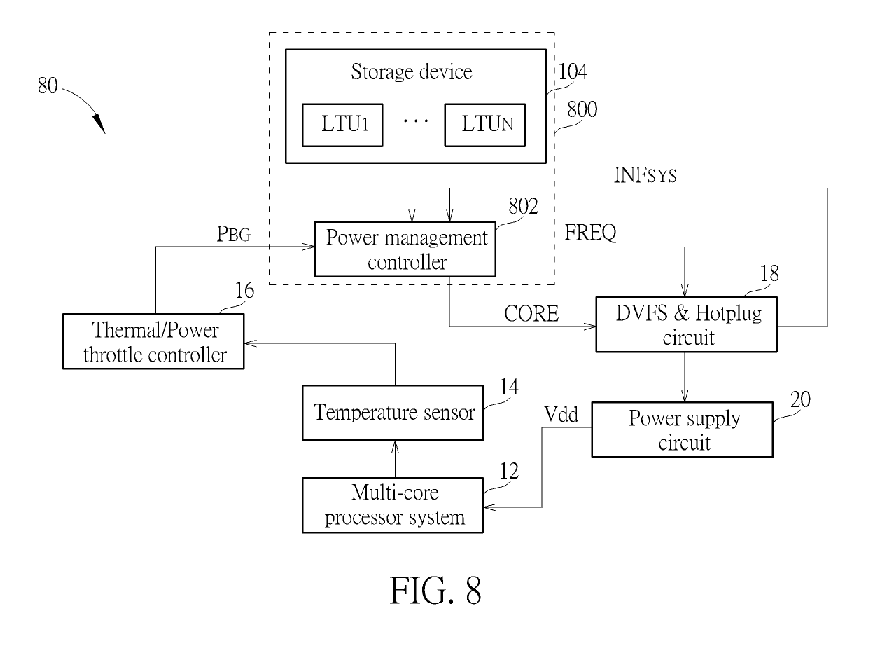

FIG. 8 is a block diagram illustrating another power budget allocation apparatus according to an embodiment of the present invention. The power budget allocation apparatus 800 may be a part of an electronic device 80. For example, the electronic device 80 may be a mobile device such as a cellular phone. The major difference between the power budget allocation apparatuses 100 and 800 is that the power budget allocation apparatus 800 receives an unverified system setting INF_{SYS} that is generated for the multi-core processor system 12 by the DVFS & hotplug circuit 18 without considering the target power budget P_{BG}, and refers to the target power budget P_{BG} and the unverified system setting INF_{SYS} to generate the power management output to the DVFS & hotplug circuit 18, wherein the power management output includes at least one of an online core setting CORE of the multi-core processor system 12 and a frequency setting FREG for each of the clusters into which processor cores of the multi-core processor system 12 are categorized. In other words, the power budget allocation apparatus 800 is configured to generate the online core setting CORE directly set to the hotplug function of the DVFS & hotplug circuit 18, and generate the frequency setting FREQ directly set to the DVFS function of the DVFS & hotplug circuit 18.

The power budget allocation apparatus 800 calculates the current power according to information given from the system setting INF_{SYS}. For example, considering a case where the multi-core processor system 12 includes “Big” processor cores, “Middle” processor cores, and “Little” processor cores using individual buck voltages, an unverified core combination setting determined for the multi-core processor system 12 and an unverified frequency setting determined for each processor core selected by the core combination setting are referenced by the power management controller 802 to search an unexpanded power table for power values associated with the processor cores, and then the found power values are used by the power management controller 802 to calculate the current power of the processor cores. For another example, considering a case where the multi-core processor system 12 includes “Big” processor cores, “Middle” processor cores and “Little” processor cores and the “Middle” processor cores and the “Little” processor cores share the same buck voltage, an unverified core combination setting determined for the multi-core processor system 12 and an unverified frequency setting (e.g., a “Big” core frequency or an aligned “Middle” and “Little” core frequency) for each processor core selected by the core combination setting are referenced by the power management controller 802 to search an expanded power table for power values associated with the processor cores, and then the found power values are used by the power management controller 802 to calculate the current power of the processor cores.

In one exemplary design, the power budget allocation apparatus 800 checks if the calculated current power is equal to or smaller than the target power budget P_{BG}. If the calculated current power is not larger than the target power budget P_{BG}, the power budget allocation apparatus 800 sets and outputs the online core setting CORE by the unverified core combination setting directly, and sets and outputs the frequency setting FREQ by the unverified frequency setting directly. That is, no frequency/core limit adjustment is made by the power budget allocation apparatus 800 when the calculated current power meets the power budget requirement.

In another exemplary design, the unverified core combination setting for the multi-core processor system 12 is referenced to set an online core limit for each cluster, and the unverified frequency settings for processor cores of the multi-core processor system 12 are referenced to set a frequency limit for each cluster. The power budget allocation apparatus 800 may initialize a currently selected online core setting of each cluster by any core combination setting, and may further initialize a currently selected frequency setting of each core combination of each cluster by any frequency setting. Next, the power budget allocation apparatus 800 may employ the same power budget allocation method of the power budget allocation apparatus 100 to iteratively update the currently selected frequency setting and/or the currently selected online core setting of each cluster according to the delta power efficiency comparison result and the target power budget P_{BG}, where the currently selected online core setting of each cluster is constrained to be equal to or smaller than the corresponding online core limit (which is set based on the unverified core combination setting provide by the DVFS & hotplug circuit 18), and the currently selected frequency setting of each cluster is constrained to be equal to or smaller than the corresponding frequency limit (which is set based on the unverified frequency setting provide by the DVFS & hotplug circuit 18).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power budget allocation method comprising:
obtaining a system setting associated with a multi-core processor system, wherein the system setting comprises a core combination setting of the multi-core processor system and further comprises a frequency setting of each processor core selected by the core combination setting;
obtaining a target power budget; and
checking, by a power management controller, at least one power management table according to the system setting and the target power budget to generate a power management output for the multi-core processor system.

2. The power budget allocation method of claim 1, wherein the system setting is a runtime system setting actually employed by the multi-core processor system, the multi-core processor system comprises a plurality of processor cores categorized into a plurality of clusters, and the power management output comprises at least one of an online core limit and a frequency limit for each of the clusters.

3. The power budget allocation method of claim 1, wherein the system setting is an unverified system setting generated for the multi-core processor system, the multi-core processor system comprises a plurality of processor cores categorized into a plurality of clusters, and the power management output comprises at least one of an online core setting and a frequency setting for each of the clusters.

4. The power budget allocation method of claim 1, wherein the multi-core processor system comprises a plurality of processor cores categorized into a plurality of clusters each supporting a plurality of core combinations; the at least one power management table comprises a delta power table and a delta efficiency table; regarding each of the core combinations supported by the cluster, the delta power table records a plurality of delta power values associated with different operating performance point (OPP) transitions, respectively, and the delta efficiency table records a plurality of delta power efficiency values associated with the different OPP transitions, respectively.

5. The power budget allocation method of claim 4, wherein heterogeneous processor cores sharing a same buck voltage are categorized into a same cluster.

6. The power budget allocation method of claim 4, wherein the different OPP transitions comprises an OPP transition between a minimum frequency setting and disabling one processor core.

7. The power budget allocation method of claim 4, wherein checking the at least one power management table according to the system setting and the target power budget to generate the power management output for the multi-core processor system comprises:
calculating a current power budget according to the system setting;
calculating a delta power budget by subtracting the current power budget from the target power budget; and
when the delta power budget is a negative value:
comparing delta power efficiency values associated with candidate OPP transitions to find a minimum delta power efficiency value, wherein the candidate OPP transitions correspond to currently selected frequency settings of specific core combinations of the clusters, and the specific core combinations of the clusters are selected by the core combination setting of the multi-core processor system; and
changing a currently selected frequency setting of a specific cluster with the minimum delta power efficiency value such that a frequency limit of the specific cluster is decreased.

8. The power budget allocation method of claim 4, wherein checking the at least one power management table according to the system setting and the target power budget to generate the power management output for the multi-core processor system comprises:
calculating a current power budget according to the system setting;
calculating a delta power budget by subtracting the current power budget from the target power budget; and
when the delta power budget is a negative value:
comparing delta power efficiency values associated with candidate OPP transitions to find a minimum delta power efficiency value, wherein the candidate OPP transitions correspond to currently selected frequency settings of specific core combinations of the clusters, and the specific core combinations of the clusters are selected by the core combination setting of the multi-core processor system; and
changing a currently selected online core setting of a specific cluster with the minimum delta power efficiency value such that an online core limit of the specific cluster is decreased.

9. The power budget allocation method of claim 4, wherein checking the at least one power management table according to the system setting and the target power budget to generate the power management output for the multi-core processor system comprises:
calculating a current power budget according to the system setting;
calculating a delta power budget by subtracting the current power budget from the target power budget; and
when the delta power budget is a positive value:
comparing delta power efficiency values associated with candidate OPP transitions to find a maximum delta power efficiency value under the target power budget, wherein the candidate OPP transitions correspond to currently selected frequency settings of specific core combinations of the clusters, and the specific core combinations of the clusters are selected by the core combination setting of the multi-core processor system; and
changing a currently selected frequency setting of a specific cluster with the maximum delta power efficiency value such that a frequency limit of the specific cluster is increased.

10. The power budget allocation method of claim 4, wherein checking the at least one power management table according to the system setting and the target power budget to generate the power management output for the multi-core processor system comprises:
calculating a current power budget according to the system setting;
calculating a delta power budget by subtracting the current power budget from the target power budget; and
when the delta power budget is a positive value:
if currently selected frequency settings of specific core combinations of the clusters are all maximum frequency settings, changing a currently selected online core setting of a specific cluster such that an online core limit of the specific cluster is increased, wherein the specific core combinations of the clusters are selected by the core combination setting of the multi-core processor system.

11. The power budget allocation method of claim 1, wherein the multi-core processor system comprises a plurality of processor cores supporting a plurality of core combinations; regarding each of the core combinations, the at least one power management table records a plurality of power budget values associated with different operating performance point (OPP) combinations, respectively, and further records a plurality of performance values associated with the different OPP combinations, respectively.

12. The power budget allocation method of claim 11, wherein checking the at least one power management table according to the system setting and the target power budget to generate the power management output for the multi-core processor system comprises:
selecting a specific OPP combination of a specific core combination associated with the core combination setting of the multi-core processor system, wherein the specific OPP combination has a maximum performance value under the target power budget; and
generating the power management output according to the specific OPP combination.

13. A power budget allocation apparatus comprising:
a storage device, configured to store at least one power management table; and
a power management controller, configured to:
obtain a system setting associated with a multi-core processor system, wherein the system setting comprises a core combination setting of the multi-core processor system and further comprises a frequency setting of each processor core selected by the core combination setting;
obtain a target power budget; and
check the at least one power management table according to the system setting and the target power budget to generate a power management output for the multi-core processor system.

14. The power budget allocation apparatus of claim 13, wherein the system setting is a runtime system setting employed by the multi-core processor system, the multi-core processor system comprises a plurality of processor cores categorized into a plurality of clusters, and the power management output comprises at least one of an online core limit and a frequency limit for each of the clusters.

15. The power budget allocation apparatus of claim 13, wherein the system setting is an unverified system setting generated for the multi-core processor system, the multi-core processor system comprises a plurality of processor cores categorized into a plurality of clusters, and the power management output comprises at least one of an online core setting and a frequency setting for each of the clusters.

16. The power budget allocation apparatus of claim 13, wherein the multi-core processor system comprises a plurality of processor cores categorized into a plurality of clusters each supporting a plurality of core combinations; the at least one power management table comprises a delta power table and a delta efficiency table; regarding each of the core combinations supported by the cluster, the delta power table records a plurality of delta power values associated with different operating performance point (OPP) transitions, respectively, and the delta efficiency table records a plurality of delta power efficiency values associated with the different OPP transitions, respectively.

17. The power budget allocation apparatus of claim 16, wherein heterogeneous processor cores sharing a same buck voltage are categorized into a same cluster.

18. The power budget allocation apparatus of claim 16, wherein the different OPP transitions comprises an OPP transition between a minimum frequency setting and disabling one processor core.

19. The power budget allocation apparatus of claim 16, wherein the power management controller generates the power management output by:
calculating a current power budget according to the system setting;
calculating a delta power budget by subtracting the current power budget from the target power budget; and
when the delta power budget is a negative value:
comparing delta power efficiency values associated with candidate OPP transitions to find a minimum delta power efficiency value, wherein the candidate OPP transitions correspond to currently selected frequency settings of specific core combinations of the clusters, and the specific core combinations of the clusters are selected by the core combination setting of the multi-core processor system; and
changing a currently selected frequency setting of a specific cluster with the minimum delta power efficiency value such that a frequency limit of the specific cluster is decreased.

20. The power budget allocation apparatus of claim 16, wherein the power management controller generates the power management output by:
calculating a current power budget according to the system setting;
calculating a delta power budget by subtracting the current power budget from the target power budget; and
when the delta power budget is a negative value:
comparing delta power efficiency values associated with candidate OPP transitions to find a minimum delta power efficiency value, wherein the candidate OPP transitions correspond to currently selected frequency settings of specific core combinations of the clusters, and the specific core combinations of the clusters are selected by the core combination setting of the multi-core processor system; and
changing a currently selected online core setting of a specific cluster with the minimum delta power efficiency value such that an online core limit of the specific cluster is decreased.

21. The power budget allocation apparatus of claim 16, wherein the power management controller generates the power management output by:
calculating a current power budget according to the system setting;
calculating a delta power budget by subtracting the current power budget from the target power budget; and
when the delta power budget is a positive value:
comparing delta power efficiency values associated with candidate OPP transitions to find a maximum delta power efficiency value under the target power budget, wherein the candidate OPP transitions correspond to currently selected frequency settings of specific core combinations of the clusters, and the specific core combinations of the clusters are selected by the core combination setting of the multi-core processor system; and
changing a currently selected frequency setting of a specific cluster with the maximum delta power efficiency value such that a frequency limit of the specific cluster is increased.

22. The power budget allocation apparatus of claim 16, wherein the power management controller generates the power management output by:
calculating a current power budget according to the system setting;
calculating a delta power budget by subtracting the current power budget from the target power budget; and
when the delta power budget is a positive value:
if currently selected frequency settings of specific core combinations of the clusters are all maximum frequency settings, changing a currently selected online core setting of a specific cluster such that an online core limit of the specific cluster is increased, wherein the specific core combinations of the clusters are selected by the core combination setting of the multi-core processor system.

23. The power budget allocation apparatus of claim 13, wherein the multi-core processor system comprises a plurality of processor cores supporting a plurality of core combinations; regarding each of the core combinations, the at least one power management table records a plurality of power budget values associated with different operating performance point (OPP) combinations, respectively, and further records a plurality of performance values associated with the different OPP combinations, respectively.

24. The power budget allocation apparatus of claim 23, wherein the power management controller selects a specific OPP combination of a specific core combination associated with the core combination setting, wherein the specific OPP combination has a maximum performance value under the target power budget; and the power management controller generates the power management output according to the specific OPP combination.
